(19) United States
(12) Patent Application Publication
(10) Pub. No.: US 2021/0293928 A1
(43) Pub. Date: Sep. 23, 2021

(54) RANGING APPARATUS, BALANCE METHOD OF SCAN FIELD THEREOF, AND MOBILE PLATFORM

(71) Applicant: SZ DJI TECHNOLOGY CO., LTD., Shenzhen (CN)

(72) Inventors: Xiongze MEI, Shenzhen (CN); Shuai DONG, Shenzhen (CN); Chenghui LONG, Shenzhen (CN); Xiaoping HONG, Shenzhen (CN)

(21) Appl. No.: 17/339,911

(22) Filed: Jun. 4, 2021

Related U.S. Application Data
(63) Continuation of application No. PCT/CN2018/119390, filed on Dec. 5, 2018.

(51) Int. Cl. G01S 7/484; G01S 7/481; G01S 17/10

(52) U.S. Cl. CPC G01S 7/484; G02B 26/10; G01S 17/10; G01S 7/4817

(57) ABSTRACT

A ranging apparatus includes an emitter, a scanner, a detector, and a controller. The emitter is configured to emit a light pulse sequence. The scanner is configured to change a transmission direction of the light pulse sequence to transmit in different directions in sequence to form a scan field. The detector is configured to receive a reflected light pulse sequence formed by an object reflecting the light pulse sequence and determine at least one of a distance or an orientation of the object relative to the ranging apparatus according to the reflected light pulse sequence. The controller is configured to control the emitter to emit the light pulse sequence at a first emission frequency when scanning the first region and at a second emission frequency higher than the first emission frequency when scanning the second region.

### CROSS-REFERENCE TO RELATED APPLICATION

This application is a continuation of International Application No. PCT/CN2018/119390, filed Dec. 5, 2018, the entire content of which is incorporated herein by reference.

### TECHNICAL FIELD

The present disclosure generally relates to the ranging technology field and, more particularly, to a ranging apparatus, a balance method of scan field thereof, and a mobile platform.

### BACKGROUND

A laser device generates a beam of high intensity and high directivity. If the beam is directed to, reflected to, or focused onto an object, the laser will be partially absorbed by the object. Thus, a temperature at the surface or inside the object will rise, which can easily cause damage. Human eyes are vulnerable to the laser with a specific wavelength (400 nm to 1400 nm), and retinas can be easily damaged. Therefore, relevant safety standards must be strictly obeyed during use of a laser.

LIDAR emits pulse laser, which cooperates with technologies such as mechanical rotation (laser and polygon mirror), micro-electromechanical system (MEMS) micro mirrors, and an optical phased array to scan a surrounding environment by using the laser to create a 3D space arrangement map.

After the pulse laser is emitted, the pulse laser is scattered or reflected by an object, and attenuated in the air. Thus, the amount of light that can reach a photodetector is small, and energy is low. As the ranging distance is increased, the energy received by the photodetector is reduced rapidly. For example, in an application scenario of an auto-pilot vehicle field, a range of the LIDAR is usually 200 m or farther, thus the pulse laser with relatively high power is required.

The laser safety standard imposes many limitations on the application of the pulse laser. A main limitation includes limiting energy of a single pulse laser and total energy of the pulse laser in a determined area within a time length from excessing the determined value. Otherwise, a safety issue may be easily caused. For the energy of the single pulse laser, the pulse laser is usually balanced during design. By considering the range and safety regulations, it is easier to limit the energy of the single pulse laser. However, in practical applications, due to a LIDAR scan manner and a laser emission strategy, limiting the total energy of the pulse laser in the determined area within the time length can impact limiting the energy of the single pulse laser.

When the LIDAR scans, emission angles of the laser are changing continuously. The emission angles of the laser are not arranged evenly in the scan field of the LIDAR. A difference can range from several to hundreds of times, and even more. When the emission angle arrangement difference of the laser is relatively large, an abnormal concentration of the laser will occur in a local area. To ensure safety, the energy of the single pulse laser must be reduced, thus, the range of the LIDAR cannot be ensured. In addition, the uneven scan angles cause uneven point cloud image density in different areas, which is not friendly to object recognition in algorithm applications.

### SUMMARY

Embodiments of the present disclosure provide a ranging apparatus including an emitter, a scanner, a detector, and a controller. The emitter is configured to emit a light pulse sequence. The scanner is configured to change a transmission direction of the light pulse sequence to transmit in different directions in sequence to form a scan field. The scan field includes a first region and a second region. A scan density of the first region is greater than a scan density of the second region. The detector is configured to receive a reflected light pulse sequence formed by an object reflecting the light pulse sequence and determine at least one of a distance or an orientation of the object relative to the ranging apparatus according to the reflected light pulse sequence. The controller is configured to control the emitter to emit the light pulse sequence at a first emission frequency when scanning the first region and at a second emission frequency higher than the first emission frequency when scanning the second region.

Embodiments of the present disclosure provide a scan field balance method. The method includes mitting a light pulse sequence, changing, via a scanner of a ranging apparatus, a transmission direction of the light pulse sequence to transmit in different directions in sequence to form a scan field, receiving a reflected light pulse sequence formed by an object reflecting the light pulse sequence, and determining at least one of a distance or an orientation of the object relative to the ranging apparatus according to the reflected light pulse sequence. The scan field includes a first region and a second region. A scan density of the first region is greater than a scan density of the second region. A first emission frequency of the light pulse sequence for scanning the first region is lower than a second emission frequency of the light pulse sequence for scanning the second region.

### BRIEF DESCRIPTION OF THE DRAWINGS

FIG. 1 is a schematic block diagram of a ranging apparatus according to some embodiments of the present disclosure.

FIG. 2 is a schematic block diagram of another ranging apparatus according to some embodiments of the present disclosure.

FIG. 3 is a schematic structural diagram showing a scanner according to some embodiments of the present disclosure.

FIG. 4 is a schematic diagram obtained by dividing a scan field in three manners according to some embodiments of the present disclosure.

FIG. 5 is a schematic diagram showing comparison between the scan field of the ranging apparatus and a scan field before the ranging apparatus is balanced according to some embodiments of the present disclosure.

FIG. 6 is a schematic flowchart showing a balance method for the scan field of the ranging apparatus according to some embodiments of the present disclosure.

FIG. 7 is a schematic architectural diagram of the ranging apparatus according to some embodiments of the present disclosure.

FIG. 8 is a schematic diagram of another ranging apparatus according to some embodiments of the present disclosure.

### DETAILED DESCRIPTION OF THE EMBODIMENTS

To make purposes, technical solutions, and advantages of the present disclosure clearer, embodiments of the present disclosure are described in conjunction with the accompanying drawings below. The described embodiments are only some embodiments not all the embodiments of the present disclosure. The present disclosure is not limited by embodiments described here. Based on the embodiments of the disclosure, all other embodiments obtained by those of ordinary skill in the art without any creative work are within the scope of the present disclosure.

In the following description, a lot of specific details are given to provide a more thorough understanding of the present disclosure. However, it is obvious to those skilled in the art that the present disclosure can be implemented without one or more of these details. In other examples, to avoid confusion with the present disclosure, some technical features known in the art are not described.

The present disclosure may be implemented in different forms and should not be understood to be limited by the described embodiments. On contrary, providing these embodiments will cause the present disclosure to be thorough and complete, and will fully convey the scope of the present disclosure to those skilled in the art.

Terms used in the present disclosure describe merely specific embodiments but are not intended to limit the present disclosure. The singular forms of “a,” “one,” and “said/the” used in the present disclosure and the appended claims are also intended to include plural forms unless the context indicates other meanings. When the terms “including” and/or “containing” are used in the specification, the existence of the described features, integers, steps, operations, elements, and/or components is determined, but do not exclude the existence or addition of one or more other features, integers, steps, operations, elements, and/or components. As used herein, the term “and/or” includes any and all combinations of related listed items.

To thoroughly understand the present disclosure, a detailed structure will be provided in the following description to explain the technical solution provided by the present disclosure. Embodiments of the present disclosure are described in detail as follows. However, in addition to these detailed descriptions, the present disclosure may also include other embodiments.

To solve the above problem, the present disclosure provides a ranging apparatus. The ranging apparatus includes an emission device, a scanner, a detection device, and a controller.

The emission device is configured to emit a light pulse sequence.

The scanner is configured to change a transmission path of the light pulse sequence emitted by the emission device to transmit the laser to different directions in sequence to form a scan field, the scan field including at least a first region and a second region, and a scan density of the first region being higher than a scan density of the second region.

The detection device is configured to receive the light pulse sequence reflected by an object to determine a distance and/or an orientation of the object relative to the ranging apparatus according to the light pulse sequence reflected.

The controller is configured to control a frequency of the emission device for emitting the light pulse sequence to cause an emission sequence of the emission device when the first region is scanned to be lower than an emission sequence of the emission device when the second region is scanned.

The ranging apparatus of the present disclosure may form the scan field through the scanner. The scan field may include at least the first region and the second region. The scan density of the first region is higher than the scan density of the second region. The ranging apparatus may further control the frequency of the emission device for emitting the light pulse sequence through the controller to cause the emission frequency of the emission device when the first region is scanned to be lower than the emission frequency of the emission device when the second region is scanned. As such, an emission frequency in a region with relatively high total light pulse energy may be reduced. Thus, total energy of pulse laser of the region may be reduced, and the total energy of the pulse laser of the regions in the scan field of the ranging apparatus may be relatively even. Within a safety range, energy of a single pulse laser may be further increased to increase the range performance of the ranging apparatus. The ranging apparatus may have a limited time for emitting the laser. The ranging apparatus of the present disclosure may reduce the frequency for emitting the light pulse (emission frequency), thus, the service life of the ranging apparatus and the power consumption may be increased. After the emission frequency of the ranging apparatus is reduced, a data amount of the point cloud of the scan field may be reduced, and a requirement for a data bandwidth during normal operation of the ranging apparatus may be lowered, which may benefit some large and complex systems. Through the ranging apparatus and a balance method for the scan field, the regions in the scan field may be scanned evenly. Thus, redundant data information due to scanning some regions with an excessive density may be cut out, and it is more friendly for object recognition in the algorithm application.

In connection with the accompanying drawings, the ranging apparatus of the present disclosure is described in detail. When there is no conflict, embodiments and features of embodiments of the present disclosure may be combined with each other.

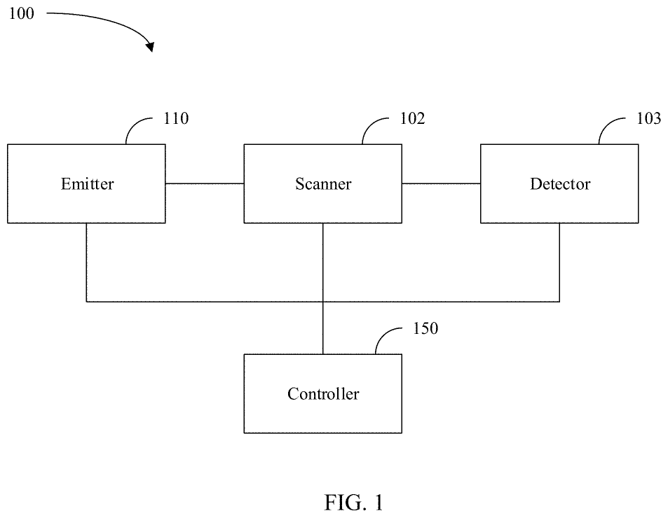

For example, as shown in FIG. 1, a ranging apparatus 100 of the present disclosure includes an emission device 110 configured to emit a light pulse sequence (a laser pulse sequence). The ranging apparatus 100 includes a LIDAR or another appropriate laser scan device.

For example, the emission device 110 may include a laser device, a switch device, and a driver. The laser device may include a diode, for example, a positive-intrinsic-negative (PIN) diode. The laser device may emit a laser pulse sequence of a certain wavelength. The laser device may be referred to as a light source or an emission light source.

The switch device may be a switch device for the laser device and may be connected to the laser device. The switch device may be configured to control the laser device to be on/off. When the laser device is on, the laser device may emit the laser pulse sequence. When the laser device is off, the laser device cannot emit the laser pulse sequence. The driver may be connected to the switch device and configured to drive the switch device.

In some embodiments, the switch device may include a metal-oxide-semiconductor field-effect transistor (MOSFET). The driver may include a MOS driver, which may be configured to drive the MOSFET that is configured as the switch device. The MOSFET may control the laser device to be on/off.

The switch device may further include a gallium nitride (GaN) transistor. The driver may include a GaN driver.

The ranging apparatus 100 further includes a scanner 102 configured to change the transmission path of the light pulse sequence emitted by the emission device to transmit the light pulse sequence at different directions in sequence to form the scan field. The scan field may include at least a first region and a second region. a scan density of the first region is larger than a scan density of the second region. A scan density of a region may refer to the quantity of the light pulses that are emitted to the region within a time length.

For example, the scan field of the ranging apparatus 100 may include a center region, a boundary region, and a middle region between the center region and the boundary region. Scan densities of the center region and/or the boundary region may be larger than a scan density of the middle region. In some embodiments, the first region may include the center region. The second region may include the boundary region or the middle region. In some other embodiments, the first region may include the boundary region, and the second region may include the center region.

Within a certain time length, the scan density of the first region may be larger than the scan density of the second region. The certain time length may be determined by the structure of the scanner and the scan strategy. For example, a scan cycle may refer to a period that the scanner forms a complete scan pattern in the scan field. Thus, within a scan cycle, the scan density of the first region may be larger than the scan density of the second region. In some embodiments, within a time length shorter or longer than a scan cycle, the scan density of the first region may be larger than the scan density of the second region.

The scan pattern may refer to a pattern formed by accumulating the scan trajectory of a beam in the scan field within a time length. Under the scan of the scanner, after forming a complete scan pattern within a scan cycle, the beam may form a next same and complete scan pattern along the same scan trajectory in a next scan cycle.

The scanner 102 may include any structure that can realize the scan field. For example, the scanner may include a mechanical-based prism scanner, a galvanometer scanner, or a micro-electromechanical system (MEMS) scanner. In some embodiments, the scanner may include a phased array-based acoustic/electro-optical scanner or a liquid crystal phased array scanner.

In some embodiments, the scanner 102 may include at least one optical element, which may be configured to change a transmission path of a beam. The optical element may be configured to change the transmission path of the beam by performing reflection, refraction, diffraction, etc. on the beam. For example, the scanner 102 may include a lens, a mirror, a prism, a galvanometer, a grating, a liquid crystal, an optical phased array, or any combination thereof. In some embodiments, at least some optical elements may be movable. For example, the at least some optical elements may move driven by a driver module. The movable optical element may reflect, refract, and diffract the beam to different directions at different times. in some embodiments, the scanner 102 includes a plurality of optical elements that may rotate or vibrate around a same axis. Each of the plurality of optical elements that rotates and vibrates may be configured to continuously change a transmission direction of an incident beam. In some embodiments, the plurality of optical elements of the scanner 102 may rotate at different rotation speeds or vibrate at different speeds. In some other embodiments, the at least some optical elements of the scanner 102 may rotate at a nearly same rotation speed. In some embodiments, the plurality of optical elements of the scanner may rotate around different axes. In some embodiments, the plurality of optical elements of the scanner may rotate in a same direction or different directions, or vibrate along a same direction or different directions, which are not limited here.

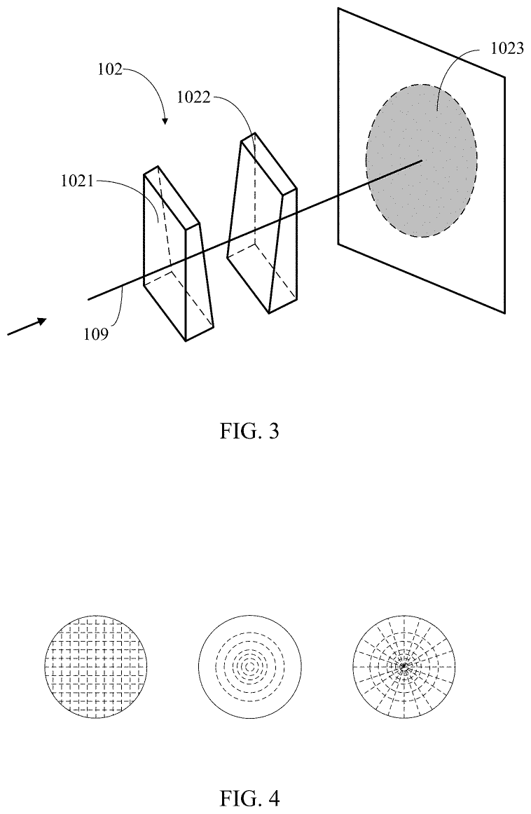

For example, as shown in FIG. 3, the scanner 102 includes at least one optical element. The at least one optical element includes a first light refraction element 1021 and a second light refraction element 1022 that are rotary and arranged opposite to each other. Each one of the first light refraction element 1021 and the second light refraction element 1022 may include a pair of non-parallel surfaces. In some embodiments, the first light refraction element 1021 and the second light refraction element 1022 may rotate around the same rotation axis, and/or the first light refraction 1021 and the second light refraction element 1022 may have different rotation speeds and/or directions. In some embodiments, the first refraction element 1021 may include a wedge prism, and/or the second refraction element 1022 may include a wedge prism.

In some embodiments, as shown in FIG. 3, the first refraction element 1021 and the second light refraction element 1022 rotate around the same rotation axis 109. The scanner 102 further includes a driver (not shown) connected to the first light refraction element 1021 and a driver (not shown) connected to the second light refraction element 1022. The driver of the first light refraction element 1021 may be configured to drive the first light refraction element 1021 to rotate around the rotation axis 109. The driver of the second light refraction element 1022 may be configured to drive the second light refraction element 1022 to rotate around the rotation axis 109.

For example, as shown in FIG. 3, after the light pulse sequence emitted from the emission device are refracted by the first light refraction element 1021 and the second light refraction element 1022 to transmit to different directions in sequence, a scan field that is nearly in a circle may be formed at a plane. The plane is proximately perpendicular to the optical axis of the beam emitted from the emission device.

In some embodiments, as shown in FIG. 1, the ranging apparatus further includes a detection device 103 that may be configured to receive the light pulse sequence reflected by the object to determine at least one of the distance or orientation of the object relative to the ranging apparatus according to the light pulse sequence reflected. In some embodiments, the detection device 103 may include a reception device, a sampling device, and a computation device. The reception device may be configured to convert the received laser pulse sequence reflected by the object into an electrical signal for output. The sampling device may be configured to perform sampling on the electrical signal output by the reception device. In some embodiments, the sampling device may be configured to measure a time difference between emission and reception of the laser pulse sequence. The computation device may be configured to receive the time difference output by the sampling device and calculate a ranging result.

As shown in FIG. 1, the ranging apparatus 100 further includes a controller 150, which may be configured to control the frequency of the emission device 110 for emitting the light pulse sequence to cause the emission frequency of the emission device when the first region is scanned to be lower than the emission frequency of the emission device when the second region is scanned. For example, when the scan field is nearly in a circle, the first region may include the center region, and the second region may include the boundary region or the middle region. The controller 150 may be configured to control the frequency of the emission device 110 for emitting the light pulse sequence to cause the emission frequency of the emission device when the center region is scanned to be lower than the emission frequency of the emission device when the boundary region or the middle region is scanned. In some embodiments, the first region may include the boundary region, and the second region may include the center region. The controller 150 may be configured to control the frequency of the emission device 110 for emitting the light pulse sequence to cause the emission frequency of the emission device when the boundary region is scanned to be lower than the emission frequency of the emission device when the center region is scanned.

In some embodiments, as shown in FIG. 1, the controller 150 is configured to control the emission device 110 to emit the light pulse sequence in a fixed emission cycle. That is, time intervals for the emission device 110 to emit two neighboring light pulses may be same. The first region may include at least a section of a non-light-emitting path. A time length needed for the scanner to scan the section of the non-light-emitting path may be longer than the emission cycle of the light pulse sequence. That is, if the emission frequency of the emission device 110 is not controlled, at least one light pulse may be emitted in the section of the non-light-emitting path. To control the emission frequency of the emission device when the first region is scanned, the controller 150 may be configured to control the emission device 110 not to emit the light pulse when the non-light-emitting path is determined. Through such a setting, the controller 150 may be configured to control the emission device no longer to emit the light pulse to the non-light-emitting path, which may originally emit light. As such, the emission frequency of the emission device for emitting the light pulse to the first region may be decreased. The total energy of the light pulse in the first region may be reduced. The total energy of the light pulses in the regions of the scan field of the ranging apparatus may be more even. The scan field may be formed by crossing and overlapping a plurality of scan trajectories. The controller 150 may be configured to select which sections of the scan trajectory are non-light-emitting path and which sections of the scan trajectory are light-emitting path in at least the first region through a random selection manner. In some other embodiments, the scan field of the ranging apparatus may be divided into a plurality of sub-regions through a regular division manner with equal intervals or an irregular division manner with unequal intervals. Some of the sub-regions may be determined as non-light-emitting regions. Each of the non-light-emitting regions may include at least a section of the non-light-emitting path. For example, the first region may include at least one non-light-emitting region. For another example, both the first region and the second region may include at least one non-light-emitting region.

A plurality of manners may be used for dividing the scan field. For example, as shown in FIG. 4, the scan field of the ranging apparatus is divided into a plurality of non-light-emitting regions and a plurality of light-emitting regions through at least one of rectangular division, annular division, or ray-shaped division. For example, from left to right in FIG. 4, three division manners of a rectangular regular division manner, an annular irregular division manner, and an annular and ray-shape combined irregular division manner are shown, which are used to divide the scan field of the ranging apparatus into the plurality of non-light-emitting regions and the plurality of light-emitting regions.

In some embodiments, the second region may include at least a section of the non-light-emitting path. The controller 150 may be configured to control the emission device not to emit the light pulse when the non-light-emitting path is determined to be scanned. Through such a setting, the emission frequency of the emission device for emitting the light pulse to the second region may be reduced. Thus, the total energy of the light pulse in the second region may be reduced. Since the scan density for scanning the first region is greater than the scan density for scanning the second region, the time length needed for the scanner 102 scanning the section of the non-light-emitting path in the first region may be longer than the time length needed for the scanner 102 scanning the section of the non-light-emitting path in the second region. As such, the length of the non-light-emitting path in the first region may be made to be longer than the length of the non-light-emitting path in the second region. Thus, a reduction degree in the emission frequency of the first region may be greater than a reduction degree in the emission frequency of the second region to balance the total energy distribution of the whole scan field.

Since the scan density for scanning the first region is greater than the scan density for scanning the second region, to cause the total energy of the light pulses of the first region and the second region to be relatively even, the reduction degree in the emission frequency of the first region may be greater than the reduction degree in the emission frequency of the second region to balance the total energy distribution of the whole scan field. A total time length needed for the scanner scanning all the non-light-emitting paths in the first region may be longer than a total time length needed for the scanner scanning all the non-light-emitting paths in the second region, and/or, a quantity of the non-light-emitting paths included in the first region may be greater than a quantity of the non-light-emitting paths included in the second region.

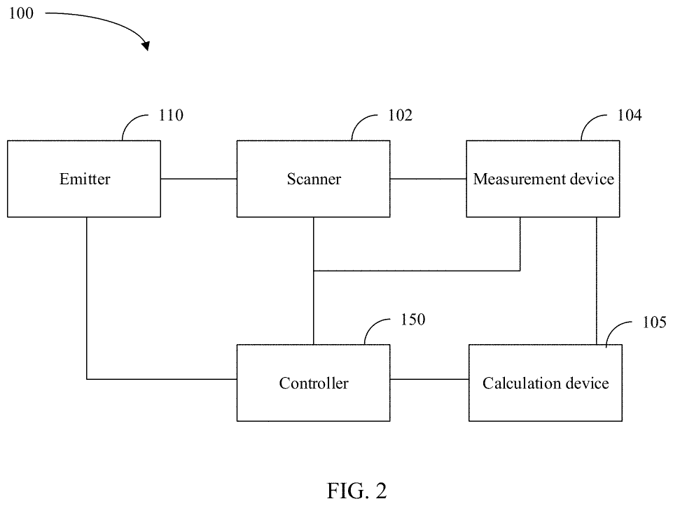

In some embodiments, the scanner 102 may include at least one movable optical element. As shown in FIG. 2, the ranging apparatus 100 further includes a measurement device 104 and a calculation device 105. The measurement device 104 may be configured to measure and obtain movement angle information of the optical element. The calculation device 105 may be configured to calculate and obtain emission angle information of the light pulse sequence based on the movement angle information. The emission angle information may be used to determine a scan region of the scanner 102. For example, the at least one movement optical element may include at least one rotary optical element or at least one vibrating optical element. The measurement device 104 may include any suitable device that can measure, for example, a rotation angle of a prism, which is not limited here.

The controller 150 may be configured to obtain the emission angle information output by the calculation device 105 and determine a scan region (or scanned light-emitting path) that is currently scanned according to the emission angle information. When the non-light-emitting path is determined to be scanned, the controller 150 may control the emission device 110 not to emit the light pulse. When the scan region that is currently scanned is determined to be a light-emitting region (or light-emitting path in the light-emitting region), the controller 150 may control the emission device 110 to emit the light pulse.

The scan field of the ranging apparatus may be divided into a plurality of sub-regions. When the light pulse is emitted periodically, a region, to which the light pulse is about to be emitted, may be determined according to the angle information of the light pulse (i.e., obtain the scan region that the scanner is currently scanning). When the laser scans the non-light-emitting region, the emission device may be controlled not to emit light during the time length of scanning the non-light-emitting region.

In some embodiments, when the at least one movable optical element includes at least one rotary optical element, the movement angle information of the optical element may include the rotation angle of the optical element. In some embodiments, the rotation angle of the optical element may include a rotation angle of a current position of the optical element relative to an initial position of the optical element, for example, the initial position may include a position where the optical element is still before starting to rotate.

By taking the double-prism scan structure shown in FIG. 3 as an example, the first refraction element 1021 and the second refraction element 1022 are driven by two drivers (e.g., motors) to rotate around the axis at different rotation speeds. When the light pulse passes through the first refraction element 1021 and the second refraction element 1022, four refractions occur, and a nearly circular scan field 1023 is formed shown in FIG. 3. Rotation angles of the current first refraction element 1021 and the second refraction element 1022 may be obtained through the measurement device. The computation device may be configured to calculate the emission angle of the light pulse according to a refraction principle to determine the region where the light pulse is about to be emitted to.

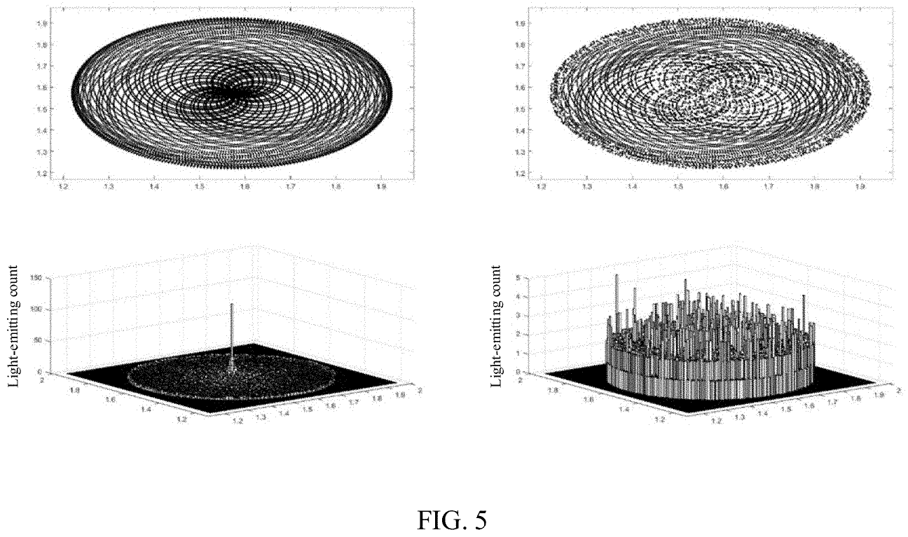

FIG. 5 shows a division of the scan field of the ranging apparatus by using a rectangular regular division manner. Abscissas in the upper two graphs in FIG. 5 are Azimuths and ordinates are the Zeniths. Z-axes in the lower two graphs in FIG. 5 are Counts, X-axes and Y-axes are Azimuths and Zeniths. The upper left graph in FIG. 5 is a schematic diagram of a scan field formed before the ranging apparatus of the present disclosure is activated. The lower left graph is a statistical distribution of the count of the light pulses in each region before the ranging apparatus of the present disclosure is activated. The count of the light pulses in the center region is higher than a count of a non-center region, at maximum, the count in the center region may be larger than 100 times of the count of the non-center region. The upper right graph shows a schematic diagram of the scan field formed by activating the ranging apparatus of the present disclosure. The lower right graph shows a statistical distribution of the count of the light pulses in each region of the scan field that is formed by activating the ranging apparatus of the present disclosure. Differences in the counts of light pulses in the scan field of the ranging apparatus of the present disclosure are controlled at about 5 times. Thus, the counts of the light pulses in the scan field become more uniform.

In some other embodiments, as shown in FIG. 1, the controller 150 may be further configured to limit the light-emitting count of the light pulse sequence emitted by the ranging apparatus 100 to the at least the first region within a certain time length to be smaller than or equal to a first threshold count to reduce the emission frequency for emitting the light pulse sequence to the first region. The certain time length may include at least a part of the scan cycle. For example, the certain time length may be a scan cycle or longer than a scan cycle. In some embodiments, the scan cycle may be divided into several time sections, which may be equal time sections or unequal time sections. The certain time length may refer to any one time section, or a sum of any time sections, or each time section. In some embodiments, the certain time length may include any time section that is set appropriately according to requirements of different scanners. For example, when the scanner includes the rotary prism, a certain number of revolutions that the prism rotates may be used as a certain time length.

The first threshold count may be smaller than a first value. The first value may be a total emission count of the light pulses of the scanner scanning the first region within one scan cycle when the emission device emits the light pulse sequence at the fixed emission cycle. The first value may be further set appropriately according to an emission count of an actual scan field.

In some embodiments, to limit the light-emitting count of the light pulse sequence emitted by the ranging apparatus 100 to at least the first region within the certain time length to be smaller than or equal to the first threshold count, the controller may be configured to count a number of times of light emission of the first region. Within the certain time length, if the count of the light emission reaches the first threshold count, the controller may be configured to control the emission device not to emit the light pulse sequence. If the light-emitting count does not reach the first threshold count, the controller may be configured to control the emission device to emit the light pulse sequence. Through such a manner, the count of the light emission of the first region may be controlled within the threshold count to reduce the emission frequency of the first region.

To reduce the emission frequency of the emission device emitting the light pulse to the second region, the controller may be further configured to limit a light-emitting count of the light pulse sequence emitted by the ranging apparatus to at least the second region within a certain time length to be smaller than or equal to a second threshold count. The certain time length may have the same setting manner as the above certain time length.

In some embodiments, a scan cycle may refer to a period that the scanner forms a complete scan pattern in the scan field. The certain time length may include a scan cycle. The second threshold count may be smaller than a second value. The second value may be a total emission count of the light pulses of the scanner scanning the second region within one scan cycle when the emission device emits the light pulse sequence at the fixed emission cycle.

In some embodiments, to limit the emission count of the light pulse sequence emitted by the ranging apparatus 100 to at least the second region within the certain time length to be smaller than or equal to the second threshold count, the controller may be configured to count a number of times of light emission of the second region. Within the certain time length, if the count of the light emission reaches the second threshold count, the controller may be configured to control the emission device not to emit the light pulse sequence. If the count of the light emission does not reach the second threshold count, the controller may be configured to control the emission device to emit the light pulse sequence. Through such a manner, the count of the light emission of the second region may be controlled within the threshold count to reduce the emission frequency of the second region.

The first threshold count and the second threshold count may have a same value or different values. In some embodiments, when the first threshold count and the second threshold count have different values, two values may have a difference within 5 times, for example, the first threshold count may be smaller than or equal to 5 times of the second threshold value.

In some embodiments, the scan field of the ranging apparatus may be divided into the plurality of regions through the regular division manner with equal intervals or the irregular division manner with unequal intervals. For example, as shown in FIG. 4, the scan field of the ranging apparatus may be divided into the plurality of regions through at least one division method of rectangular division, annular division, or ray-shaped division. For example, the scan field of the ranging apparatus may be divided into the plurality of regions through the three division manners of the rectangular regular division manner, the annular irregular division manner, and the annular and ray-shaped combined irregular division manner shown in FIG. 4 from left to right. The plurality of regions include the first region and the second region.

In some embodiments, the controller 150 may be configured to limit the light-emitting count of the light pulse sequence emitted by the ranging apparatus to each of the regions within the certain time length to be smaller than or equal to the threshold count. The threshold count may be appropriately set according to the scan density distribution of the actual scan field. In some embodiments, total emission counts may be same or close when the scanner scans the regions within one scan cycle.

In some embodiments, to limit the light-emitting count of the light pulse sequence emitted by the ranging apparatus to each of the regions within the certain time length to be smaller than or equal to the threshold count, the controller may be configured to count the light-emitting times of each region. Within the certain time length, if the count of the light emission reaches the threshold count, the controller may be configured to control the emission device not to emit the light pulse sequence. If the count of the light emission does not reach the threshold count, the controller may be configured to control the emission device to emit the light pulse sequence. That is, when the scanner scans the region, if the light-emitting count of the region reaches the threshold count, the emission device may not emit the light pulse sequence. If the light-emitting count of the region does not reach the threshold count, the emission device may emit the light pulse sequence.

In some embodiments, the scanner 102 may include at least one movable optical element. As shown in FIG. 2, the ranging apparatus 100 further includes the measurement device 104 and the calculation device 105. The measurement device 104 may be configured to measure and obtain the movement angle information of the optical element. The calculation device 105 may be configured to calculate and obtain the emission angle information of the light pulse sequence based on the movement angle information. The emission angle information may be used to determine a scan region of the scanner 102. For example, the at least one movement optical element may include at least one rotary optical element or at least one vibrating optical element. The measurement device 104 may include any suitable device that can measure, for example, a rotation angle of a prism, which is not limited here.

In some embodiments, the controller 150 may be further configured to clear the counted light emitting times when the certain time length ends and limit a light-emitting count of a light pulse sequence emitted by the ranging apparatus to at least the first region within a next certain time length to be smaller than or equal to the first threshold count. In some embodiments, when the certain time length ends, the controller 150 may clear the counted light emitting times of each region and limit the light-emitting count of the light pulse sequence emitted by the ranging apparatus to each region within the next certain time length to be smaller than or equal to a corresponding threshold count. By clearing the counted light emitting times, the controller may start counting and determination of the next certain time length.

In some embodiments, the emission device may emit the light pulses cyclically. The emission quantity of the light pulses of some regions may be reduced by controlling the emission device not to emit the light pulses at the moment when the light pulses should be emitted. In some other embodiments, the emission device may not be controlled in a cyclical emission manner to emit the light pulses, but the scan field may be divided into the plurality of regions. The plurality of regions may include light-emitting regions and non-light-emitting regions. The controller may control the emission device to emit the light pulses when a light-emitting region is scanned. One light pulse may be emitted each time the light-emitting region is scanned, or a plurality of light pulses may be emitted continuously according to a fixed frequency each time the light-emitting region is scanned. When a non-light-emitting region is scanned, the controller may control the emission device not to emit the light pulse. In some embodiments, the emission device may no longer emit the light pulse according to the predetermined fixed frequency but may determine whether to emit the light pulse according to the region that is scanned. In some embodiments, division resolution of the light-emitting regions and the non-light-emitting regions may be relatively high, that is, division region areas of the light-emitting regions and the non-light-emitting regions can be smaller.

Through such a setting manner, the emission frequencies of some regions of the scan field may be controlled by causing some regions to emit light and some regions not to emit light. The emission frequency of the light pulses of the region with the large scan density may be reduced to cause the total energy of the whole scan field to be distributed more evenly. For the count of emitting the light pulses, differences among the emission counts of the light pulses of different regions of the whole scan field may become small.

In some embodiments, the scan path within a scan cycle may be cut into light-emitting path sections and non-light-emitting path sections. In the scan cycle, when a light-emitting path section is scanned, the controller may control the emission device to emit the light pulse. One light pulse may be emitted each time the light-emitting path section is scanned, or a plurality of light pulses may be emitted continuously each time the light-emitting path section is scanned. When a non-light-emitting path section is scanned, the controller may control the emission device not to emit light.

In some embodiments, when the scan field is divided into the plurality of regions, in different periods, the plurality of regions may have different light-emitting settings. For example, in a first period, regions of a first portion may be determined to be the light-emitting regions, and the rest regions may be determined to be the non-light-emitting regions. In a second period, regions of a second portion may be determined to be the light-emitting regions, and the rest regions may be determined to be the non-light-emitting regions. The regions of the first portion and the regions of the second portion may be completely different or partially same. The first period and the second period may be two periods within a scan cycle, or two scan cycles, or another two periods, which is not limited here.

The scan field may be divided into the plurality of regions by using the method above. The plurality of regions may include the light-emitting regions and the non-light-emitting regions. For example, the scan field of the ranging apparatus may be divided into the plurality of light-emitting regions and the plurality of non-light-emitting regions in the regular division manner with equal intervals and the irregular division manner with the unequal intervals. In some embodiments, as shown in FIG. 4, the scan field of the ranging apparatus may be divided into the plurality of light-emitting regions and the plurality of non-light-emitting regions through at least one division method of rectangular division, annular division, or ray-shaped division. For example, the scan field of the ranging apparatus may be divided into the plurality of light-emitting regions and the plurality of non-light-emitting regions through the three division manners of the rectangular regular division manner, the annular irregular division manner, and the annular and ray-shaped combined irregular division manner shown in FIG. 4 from left to right.

In some embodiments, the controller 150 may be configured to determine a next light-emitting region according to the light-emitting region that is currently scanned by the scanner. When the scanner scans the next light-emitting region, the controller 150 may control the emission device to emit the light pulse, otherwise, the controller 150 may control the emission device not to emit the light pulse. The controller may need to obtain the scan region that is currently scanned by the scanner in real-time. For example, the emission angle information of the light pulse sequence may be determined by the measurement device 104 and the calculation device 105. The emission angle information may be used to determine the scan region of the scanner 102.

In some other embodiments, the emission angle information for determining the scan region (i.e., a region that the light pulse is about to be emitted to) of the scanner 102 may be replaced by other information of the ranging apparatus, because the emission angle of the light pulse may be determined by the mechanical rotation, the MEMS micromirror, and the optical phase array. For example, for the double-prism structure shown in FIG. 3, when the angle of the light pulse emitted by the emission device is known, the rotation angles of the two prisms may directly determine the final emission angle of the light pulse. Therefore, the rotation angles of the two prisms may be used as a basis to determine whether to the light pulse.

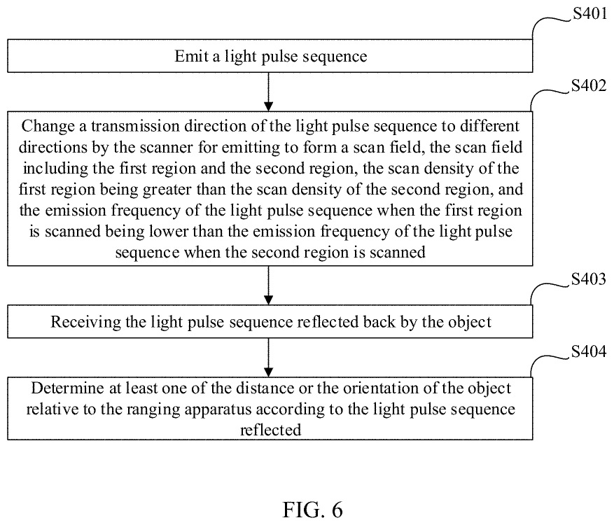

Based on the ranging apparatus, the present disclosure further provides a balance method for the scan field of the ranging apparatus. The ranging apparatus includes the scanner. As shown in FIG. 6, the balance method includes the following processes.

At S401, a light pulse sequence is emitted. Emitting the light pulse sequence may include emitting a laser pulse sequence. The ranging apparatus 100 may include a LIDAR or another suitable light scan device.

At S402, a transmission direction of the light pulse sequence is changed to different directions by the scanner for emitting to form a scan field. The scan field may include the first region and the second region. The scan density of the first region may be greater than the scan density of the second region. The emission frequency of the light pulse sequence when the first region is scanned may be lower than the emission frequency of the light pulse sequence when the second region is scanned.

In some embodiments, the scan field of the ranging apparatus may include the center region, the boundary region, and the middle region between the center region and the boundary region. The scan densities of the center region and/or the boundary region may be larger than the scan density of the middle region. In some embodiments, the first region may include the center region. The second region may include the boundary region or the middle region. In some other embodiments, the first region may include the boundary region, and the second region may include the center region.

Within a certain time length, the scan density of the first region may be greater than the scan density of the second region. The certain time length may be appropriately set according to the actual needs. For example, a scan cycle may refer to a period that the scanner forms a complete scan pattern in the scan field. Thus, within a scan cycle, the scan density of the first region may be greater than the scan density of the second region. In some embodiments, within a time length shorter or longer than the scan cycle, the scan density of the first region may be greater than the scan density of the second region.

In some embodiments, the scanner 102 may include at least one optical element, which may be configured to change a transmission path of a beam. The optical element may be configured to change the transmission path of the beam by performing reflection, refraction, diffraction, etc. on the beam. For example, the scanner 102 may include a lens, a mirror, a prism, a galvanometer, a grating, a liquid crystal, an optical phased array, or any combination thereof.

By taking the scanner including at least one movable optical element as an example, the at least one movable optical element may include the first refraction element and the second refraction element that are rotary and arranged oppositely. Each one of the first light refraction element and the second light refraction element may include a pair of non-parallel surfaces. The first refraction element may include a wedge prism, and/or the second refraction element may include a wedge prism.

In some embodiments, emitting the light pulse sequence may include emitting the light pulse sequence at the fixed emission cycle. The first region may include the plurality of non-light-emitting paths. The time length needed for the scanner scanning a section of a non-light-emitting path may be longer than the emission cycle. To reduce the emission frequency of the light pulse sequence when the first region is scanned, the balance method may further include not emitting the light pulse when determining that the non-light-emitting path is scanned in the first region.

The second region may include at least a section of the non-light-emitting path. The time length needed for the scanner scanning the section of the non-light-emitting path of the first region may be longer than the time length needed for the scanner scanning a section of a non-light-emitting path of the second region. The balance method may further include not emitting the light pulse when determining that the non-light-emitting path of the second region is scanned to reduce the emission frequency of emitting the light pulse to the second region. That is, when it is determined that the non-light-emitting path of the first region or the second region is scanned, the light pulse is not emitted.

In some embodiments, the total time length needed for the scanner scanning all the non-light-emitting paths in the first region may be longer than the total time length needed for the scanner scanning all the non-light-emitting paths in the second region. In some other embodiments, the quantity of the non-light-emitting paths included in the first region may be greater than the quantity of the non-light-emitting paths included in the second region. The purpose of the above setting may include causing the reduction degree in the emission frequency of the first region to be greater than the reduction degree of the emission frequency of the second region to balance the total energy distribution of the whole scan field.

To control the emission frequency of the light pulse when the first region is scanned, the balance method may include when determining that the non-light-emitting path is scanned, controlling the emission device not to emit the light pulse. Through such a manner, the emission device may not emit the light pulse to the non-light-emitting path that should emit light originally to reduce the emission frequency of emitting the light pulse to the first region. Thus, the total energy of the light pulse in the first region may be reduced, and the total energy of the light pulses of the regions of the scan field of the ranging apparatus may be relatively more even. The scan field may be formed by crossing and overlapping the plurality of scan trajectories. Which sections of the scan trajectories of the scan field are the non-light-emitting path and which sections of the scan trajectories of the scan field are the light-emitting path may be selected in a random selection manner. In some other embodiments, the scan field of the ranging apparatus may be divided into the plurality of regions through the regular division manner with the equal intervals or the irregular division manner with the unequal intervals. Each non-light-emitting region may include at least a section of the non-light-emitting path. The first region may include at least one non-light-emitting region. The second region may include at least one non-light-emitting region.

For example, as shown in FIG. 4, the scan field of the ranging apparatus may be divided into the plurality of non-light-emitting regions and the plurality of light-emitting regions through at least one division method of the rectangular division, the annular division, or the ray-shaped division. For example, the scan field of the ranging apparatus may be divided into the plurality of non-light-emitting regions and the plurality of light-emitting regions through the three division manners of the rectangular regular division manner, the annular irregular division manner, and the annular and ray-shaped combined irregular division manner shown in FIG. 4 from left to right.

In some embodiments, the scanner may include at least one movable optical element. The balance method may further include measuring the movement angle information of the optical element and calculating the emission angle information of the light pulse sequence based on the movement angle information. The emission angle information may be used to determine the scan region of the scanner. Through this method, the scan region (or the scan trajectory that is scanned) that is currently scanned may be determined according to the emission angle information. When determining that the non-light-emitting path is scanned, the method may include not emitting the light pulse. When determining that the scan region that is currently scanned is the light-emitting region (or light-emitting path of the light-emitting region), the method may include emitting the light pulse.

In some embodiments, when the at least movable optical element may include at least one rotary optical element, the movement angle information of the optical element may include the rotation angle of the optical element. In some embodiments, the rotation angle of the optical element may include the rotation angle of the current position of the optical element relative to the initial position of the optical element. For example, the initial position may include the position where the optical element is still before starts to rotate.

In some other embodiments, to reduce the emission frequency of at least the first region, the balance method may include limiting the light-emitting count of the light pulse sequence emitted by the ranging apparatus to the at least the first region within the certain time length to be smaller than or equal to the first threshold count. In some embodiments, the scan cycle may refer to a period that the scanner forms a complete scan pattern in the scan field. The certain time length may include a scan cycle. The first threshold count may be smaller than the first value. The first value may be a total emission count of the light pulses of the scanner scanning the first region within one scan cycle when the emission device emits the light pulse sequence at the fixed emission cycle. In some embodiments, limiting the light-emitting count of the light pulse sequence emitted by the ranging apparatus to the at least the first region within the certain time length to be smaller than or equal to the first threshold count may include counting the light-emitting count of the first region and not emitting the laser pulse sequence within the certain time length when the light-emitting count reaches the first threshold count. By limiting the light-emitting count of the first region within the certain time length, the emission frequency of the first region with the large scan density may be reduced to reduce the energy distribution of the first region.

Further, to reduce the emission frequency of the second region, the balance method may further include limiting the light-emitting count of the light pulse sequence emitted by the ranging apparatus to the at least the second region within the certain time length to be smaller than or equal to the second threshold count. In some embodiments, the scan cycle may refer to a period that the scanner forms a complete scan pattern in the scan field. The certain time length may include a scan cycle. The second threshold count may be smaller than a second value. The second value may be a total emission count of the light pulses of the scanner scanning the second region within one scan cycle when the emission device emits the light pulse sequence at the fixed emission cycle. In some embodiments, limiting the light-emitting count of the light pulse sequence emitted by the ranging apparatus to the at least the second region within the certain time length to be smaller than or equal to the second threshold count may include counting the light-emitting count of the second region and not emitting the laser pulse sequence within the certain time length when the light-emitting count reaches the first threshold count. By limiting the light-emitting count of the second region within the certain time length, the emission frequency of the second region with the large scan density may be reduced to reduce the energy distribution of the second region.

In addition to the certain time length being the scan cycle, the scan cycle may be divided into several time sections. The certain time length may include any one time section, a sum of any time sections, or each time section of the several time sections.

The first threshold count and the second threshold count may have a same value or different values. In some embodiments, when the first threshold count and the second threshold count have different values, two values may have a difference within 5 times, for example, the first threshold count may be smaller than or equal to 5 times of the second threshold value.

Further, limiting the light-emitting count of the light pulse sequence emitted by the ranging apparatus to at least one of the first region or the second region to be smaller than or equal to the threshold count may include clearing the counted light-emitting count when the certain time length ends and limiting the light-emitting count of the light pulse sequence emitted by the ranging apparatus to at least one of the first region or the second region within the next certain time length to be smaller than or equal to a corresponding threshold count. By clearing the counted light-emitting count, the counting and determination of the next certain time length may be started.

In some embodiments, the scan field may be divided into the plurality of regions in the regular division manner with equal intervals and the irregular division manner with unequal intervals. For example, as shown in FIG. 4, the scan field of the ranging apparatus may be divided into the plurality of regions through at least one division method of the rectangular division, the annular division, or the ray-shaped division. For example, the scan field of the ranging apparatus may be divided into the plurality of regions through the three division manners of the rectangular regular division manner, the annular irregular division manner, and the annular and ray-shaped combined irregular division manner shown in FIG. 4 from left to right. The plurality of regions may include the first region and the second region.

The balance method may include limiting the light-emitting count of the light pulse sequence emitted by the ranging apparatus to each of the plurality of regions within the certain time length to be smaller than or equal to the threshold count. The threshold count may be appropriately set according to the scan density distribution of the actual scan field. In some embodiments, when the emission device emits the light pulse sequence at the fixed emission cycle, an average emission count obtained by dividing the total emission count of the light pulses for the scanner scanning the scan field within the scan cycle by the quantity of the plurality of regions after the division as the threshold count of each of the plurality of regions.

In some embodiments, to limit the light-emitting count of the light pulse sequence emitted by the ranging apparatus to each of the plurality of regions within the certain time length to be smaller than or equal to the threshold count, the balance method may include counting the light-emitting count of each of the plurality of regions and not emitting the light pulse sequence within the certain time length when the light-emitting count reaches the threshold count. That is, when the region is scanned by the scanner, if the light-emitting count of the region reaches the threshold count, the emission device may not emit the light pulse sequence, and if the light-emitting count of the region does not reach the threshold count, the emission device may emit the light pulse sequence.

In some other embodiments, as shown in FIG. 4, the scan field is divided into the plurality of regions. The plurality of regions may include the light-emitting regions and the non-light-emitting regions. For the specific division methods, reference may be made to the above-related description, which is not repeated here. The method of causing the emission frequency of the light pulse sequence when the first region is scanned to be lower than the emission frequency of the light pulse sequence when the second region is scanned may include emitting the light pulse when the light-emitting region is scanned and not emitting the light pulse when the non-light-emitting region is scanned. In some embodiments, the method of causing the emission frequency of the light pulse sequence when the first region is scanned to be lower than the emission frequency of the light pulse sequence when the second region is scanned may include determining the next light-emitting region according to the light-emitting region that is currently scanned by the scanner and emitting the light pulse sequence when the scanner scans the next light-emitting region. The emission angle information of the light pulse sequence may be determined through the method or the corresponding module of the ranging apparatus of the above embodiments. The emission angle information may be used to determine the scan region of the scanner. Emitting the light pulse when the light-emitting region is scanned may include emitting one light pulse each time a light-emitting region is scanned or emitting a plurality of light pulses continuously at the fixed frequency each time the light-emitting region is scanned.

Through the method of embodiments of the present disclosure, some regions may be caused to emit light, and some regions may be caused not to emit light. The emission frequency of some regions of the scan field may be controlled. The emission frequency of the light pulse of the region with large scan density may be reduced. Thus, the total energy of the whole scan field may be distributed more evenly. For the count of emitting the light pulse, differences among the emission counts of the light pulses of different regions of the whole scan field may become small.

After the scan field is balanced through the above method, receiving the light pulse sequence reflected by the object may be performed in process S403. Any suitable method may be used to realize the reception of the light pulse sequence reflected by the object, which is not limited.

In process S404, at least one of the distance or the orientation of the object relative to the ranging apparatus may be determined according to the light pulse sequence reflected. In some embodiments, process S404 may include converting the received light pulse sequence reflected by the object into an electrical signal for output, sampling the electrical signal to measure the time difference between the emission and reception of the light pulse sequence, and receiving the time difference and calculating at least one of the ranging result or the orientation.

In summary, the ranging apparatus and balance method of embodiments of the present disclosure may electively emit the light pulse. The emission frequencies (frequency) of the light pulses of the regions with the high total energy may be reduced within a time section. Thus, the total energy of the light pulses of these regions may be reduced. For example, the total energy of the light pulses of the regions of the scan field of the ranging apparatus of the LIDAR may be relatively even. Within the safety regulation, the energy of the single light pulse may be further increased to improve the range performance of the ranging apparatus.

Since the light-emitting time of the emission device (e.g., an emission device including a laser device) included in the ranging apparatus is limited, emitting light selectively may reduce the frequency of the laser device emitting light. Therefore, the service life of the laser device may become longer, and the power consumption may be reduced.

The frequency of emitting the laser is reduced, the data amount of the point cloud may be reduced. The requirement of the LIDAR for the data bandwidth during the normal operation may be lowered, which may benefit some large and complex systems.

After the point balance solution is used, the regions of the scan field of the LIDAR may be scanned evenly. The redundant data information due to excessively dense scanning of some regions may be cut out, and it is more friendly for object recognition in the algorithm application.

The balance method for the scan field and improvement solutions of the ranging apparatuses provided by embodiments of the present disclosure may be applied to the ranging apparatus. The ranging apparatus may include an electronic apparatus such as a LIDAR, a laser ranging apparatus, etc. in some embodiments, the ranging apparatus may be configured to sense external environment information, for example, distance information, orientation information, reflection intensity information, and speed information of an environment target. In some embodiments, the ranging apparatus may detect a distance of a detected object to the ranging apparatus by measuring light transmission time, i.e., time-of-flight (TOF), between the ranging apparatus and the detected object. In some other embodiments, the ranging apparatus may detect the distance of the detected object to the ranging apparatus through another technology, for example, a ranging method based on phase shift measurement or a ranging method based on frequency shift measurement, which is not limited here.

To facilitate understanding, a ranging operation process is exemplarily described in connection with a ranging apparatus 100 in FIG. 100.

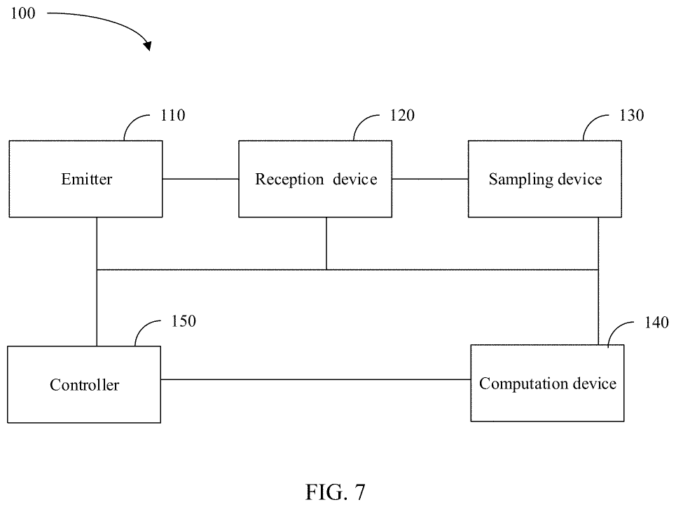

As shown in FIG. 7, the ranging apparatus 100 includes an emission device 110, a reception device 120, a sampling device 130, and a computation device 140. The emission device 110 may include an emission circuit, the reception device 120 may include a reception circuit, the sampling device 130 may include a sampling circuit, and the computation device may include a computation circuit.

The emission device 110 may be configured to emit a light pulse sequence (e.g., a laser pulse sequence). The reception device 120 may be configured to receive the light pulse sequence reflected by the detected object, perform photoelectric conversion on the light pulse sequence to obtain an electrical signal, and output the processed electrical signal to the sampling device 130. The sampling device 130 may be configured to perform sampling on the electrical signal to obtain a sampling result. The computation device 140 may be configured to determine the distance between the ranging apparatus 100 and the detected object based on the sampling result of the sampling device 130.

In some embodiments, the ranging apparatus 100 further includes a controller 150. The controller 150 may be configured to control another module or circuit. For example, the controller 150 may be configured to control the operation time of the modules and circuits and/or perform parameter setting on the modules and the circuits.

Although the ranging apparatus shown in FIG. 7 includes one emission device, one reception device, one sampling device, and one computation device, configured to emit one beam for detection, the present disclosure is not limited to this. A quantity of any one circuit of the emission device, the reception device, the sampling device, and the computation device may be at least two, such that the ranging apparatus may be configured to emit at least two beams along a same direction or different directions and at the same time or different times. In some embodiments, light-emitting dies of the at least two emission devices may be packaged in a same module. For example, each emission device may include a laser emission die. The laser emission dies of the at least two emission devices may be packaged together and be accommodated in a same package space.

In some embodiments, in addition to the structure shown in FIG. 7, the ranging apparatus 100 further includes a scanner, which may be configured to change the transmission direction of the at least one laser pulse sequence emitted by the emission device for transmission.

A module that includes the emission device 110, the reception device 120, the sampling device 130, and the computation device 140, or a module that includes the emission device 110, the reception device 120, the sampling device 130, the computation device 140, and the controller 150 may be referred to as a ranging device. The ranging device may be independent of another module, for example, a scanner.

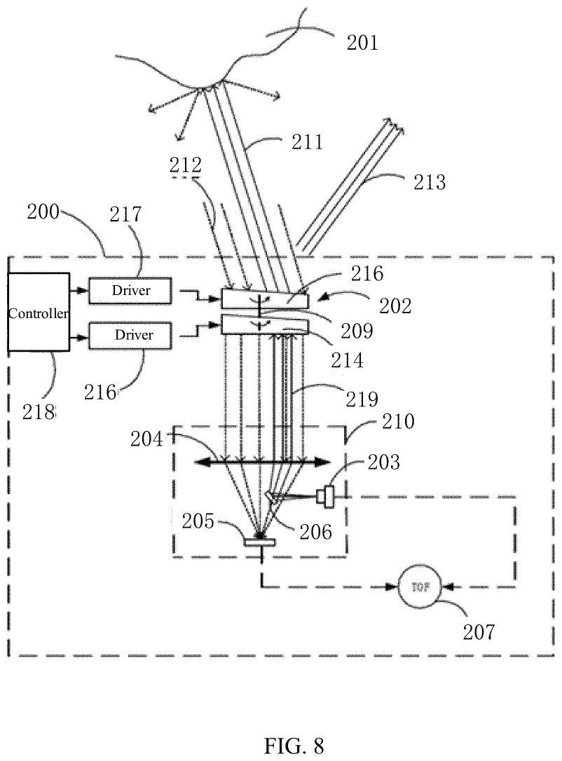

In some embodiments, a co-axial optical path may be used in the ranging apparatus. That is, the beam emitted from the ranging apparatus and a beam reflected may share at least a part of the optical path in the ranging apparatus. For example, the at least one beam of the laser pulse sequence emitted by the emission device may be emitted after the transmission direction of the at least one beam of the laser pulse sequence is changed by the scanner. The laser pulse sequence reflected by the detected object may enter into the reception device through the scanner. In some other embodiments, off-axial optical paths may be used in the ranging apparatus. That is, the beam emitted by the ranging apparatus and the beam reflected may be transmitted along different paths in the ranging apparatus. FIG. 8 is a schematic diagram of a ranging apparatus 200 using a coaxial optical path according to some embodiments of the present disclosure.

The ranging apparatus 200 includes a ranging device 210. The ranging device 210 includes an emitter 203 (including the emission device), a collimation element 204, a detector 205 (including the reception device, the sampling device, and the computation device), and an optical path change element 206. The ranging device 210 may be configured to emit a beam, receive a returned beam, and convert the returned beam into an electrical signal. The emitter 203 may be configured to emit an optical pulse sequence. In some embodiments, the emitter 203 may emit a laser pulse sequence. In some embodiments, the laser beam emitted by the emitter 203 may include a narrow bandwidth beam with a wavelength outside of a visible light range. The collimation element 204 may be further configured to converge at least a part of the returned beam reflected by the detected object. The collimation element 204 may include a collimation lens or another element that can collimate the beam.

In some embodiments shown in FIG. 8, an emission optical path and a reception optical path of the ranging apparatus may be combined through the optical path change element 206 before the collimation element 204. Thus, the emission optical path and the reception optical path may share the same collimation element to cause the optical path to be more compact. In some other embodiments, each of the emitter 203 and the detector 205 may include a collimation element 204. The optical path change element 206 may be arranged at the optical path after the collimation element 204.

In some embodiments shown in FIG. 8, since a diameter of a beam hole of the emitter 203 for emitting the beam is relatively small, and a diameter of a beam hole of the ranging apparatus for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted beam of the emitter 203. The reflection mirror may be configured to reflect the returned beam to the detector 205. As such, when a small reflection mirror is used, shielding of the returned beam by the holder of the small reflection mirror may be reduced.

In some embodiments shown in FIG. 8, the optical path change element 206 may be off the optical path of the collimation element 204. In some other embodiments, the optical path change element 206 may be located at the optical path of the collimation element 204.

The ranging apparatus 200 further includes a scanner 202. The scanner 202 is arranged at the emission optical path of the ranging device 210. The scanner 202 may be configured to change a transmission direction of a collimated beam 219 emitted through the collimation element 204 and project to an external environment, and project the returned beam to the collimation element 204. The returned beam may be converged at the detector 205 through the collimation element 204.

In some embodiments, the scanner 202 may include at least one optical element, which may be configured to change the transmission direction of the beam. The optical element may be configured to change the transmission direction of the beam by performing reflection, refraction, and diffraction on the beam. For example, the scanner 202 may include a lens, a reflection mirror, a prism, a galvanometer, a grating, a liquid crystal, an optical phased array, or any combination thereof. In some embodiments, at least a part of the optical elements may be movable. For example, at least a part of the optical elements may be driven to move by a drive module. The movable optical elements may reflect, refract, and diffract the beam to different directions at different times. In some embodiments, a plurality of optical elements of the scanner 202 may rotate at different rotation speeds or vibrate at different speeds. In some other embodiments, at least the part of the optical elements of the scanner 202 may rotate at a nearly same rotation speed. In some other embodiments, the plurality of optical elements of the scanner may rotate around different rotation axes. In some other embodiments, the plurality of optical elements of the scanner may rotate in a same direction or in different directions, or vibrate in a same direction or different directions, which is not limited here.

In some embodiments, the scanner 202 includes a first optical element 214 and a driver 216 connected to the first optical element 214. The driver 216 may be configured to drive the first optical element 214 to rotate around a rotation axis 209 to cause the first optical element 214 to change the direction of the collimated beam 219. The first optical element 214 may project the collimated beam 219 in different directions. In some embodiments, an included angle between the direction of the collimated beam 219 after the first optical element and the rotation axis 109 may change as the first optical element 214 rotates. In some embodiments, the first optical element 214 includes a pair of opposite surfaces that are not parallel. The collimated beam 219 may pass through the pair of surfaces. In some embodiments, the first optical element 214 may include at least a lens, whose thickness changes along a radial direction. In some embodiments, the first optical element 214 may include a wedge prism, which may be configured to refract the collimated beam 219.

In some embodiments, the scanner 202 further includes a second optical element 215. The second optical element 215 may rotate around the rotation axis 209. The second optical element 215 and the first optical element 214 may have different rotation speeds. The second optical element 215 may be configured to change the direction of the beam projected by the first optical element 214. In some embodiments, the second optical element 215 may be connected to another driver 217. The driver 217 may be configured to drive the second optical element 215 to rotate. The first optical element 214 and the second optical element 215 may be driven by the same driver or different drivers to cause the rotation speeds and/or the rotation directions of the first optical element 214 and the second optical element 215 to be different. Thus, the collimated beam 219 may be projected to different directions of external space to scan a relatively large space area. In some embodiments, a control 218 may be configured to control the drivers 216 and 217 to drive the first optical element 214 and the second optical element 215, respectively. The rotation speeds of the first optical element 214 and the second optical element 215 may be determined according to an expected scan area and style in practical applications. The drivers 216 and 217 may include motors or other drivers.

In some embodiments, the second optical element 215 may include a pair of opposite surfaces that are not parallel. The beam may pass through the pair of surfaces. In some embodiments, the second optical element 215 may include at least a lens whose thickness changes along a radial direction. In some embodiments, the second optical element 215 may include a wedge prism.

In some embodiments, the scanner 202 may include a third optical element (not shown in the figure) and a driver for driving the third optical element. In some embodiments, the third optical element may include a pair of opposite surfaces that are not parallel. The beam may pass through the pair of surfaces. In some embodiments, the third optical element may include at least a lens whose thickness changes along a radial direction. In some embodiments, the second optical element 215 may include a wedge prism. At least two of the first optical element, the second optical element, and the third optical element may rotate at different rotation speeds and/or in different directions.

The optical elements of the scanner 202 may rotate to project a beam to different directions, for example, a direction 213 of the projected beam 211. As such, the scanner 202 may scan the space around the ranging apparatus 200. When the projected beam 211 of the scanner 202 encounters the detected object 201, a part of the beam may be reflected by the detected object 201 along an opposite direction to the direction of the projected beam 211 to the ranging apparatus 200. The returned beam 212 reflected by the detected object 201 may be incident to the collimation element 204 after passing through the scanner 202.

The detector 205 and the emitter 203 may be arranged at a same side of the collimation element 204. The detector 205 may be configured to convert at least the part of the returned beam that passes through the collimation element 204 into an electrical signal.

In some embodiments, the optical elements may be coated with an anti-reflection film. In some embodiments, the thickness of the anti-reflection film may be equal to or close to a wavelength of the beam emitted by the emitter 203. The anti-reflection film may increase the intensity of the transmitted beam.

In some embodiments, a filter layer may be coated on a surface of an element of the ranging apparatus in the transmission path of the beam, or a filter may be arranged in the transmission path of the beam, which may be configured to transmit the light with a wavelength within the wavelength band of the beam emitted by the emitter and reflect the light of another wavelength band. Thus, the noise caused by environmental light may be reduced for the receiver.

In some embodiments, the emitter 203 may include a laser device. The light pulse in the nano-second level may be emitted by the laser device. Further, the reception time of the light pulse may be determined. For example, the reception time of the light pulse may be determined by detecting at least one of the ascending edge time or the descending edge time of the electrical signal pulse. For example, the ranging apparatus 200 may calculate the TOF by using the pulse reception time information and the pulse transmission time information to determine the distance between the detected object 201 and the ranging apparatus 200.

The distance and orientation detected by the ranging apparatus 200 may be used for remote sensing, obstacle avoidance, surveying and mapping, modeling, navigation, etc. in some embodiments, the ranging apparatus of embodiments of the present disclosure may be applied to a mobile platform. The ranging apparatus may be mounted at a platform body of the mobile platform. The mobile platform having the ranging apparatus may perform measurement on the external environment. For example, a distance between the mobile platform and an obstacle may be measured to avoid the obstacle, and 2-dimensional and 3-dimensional surveying and mapping may be performed on the external environment. In some embodiments, the mobile platform may include at least one of an unmanned aerial vehicle (UAV), a vehicle (including a car), a remote vehicle, a ship, a robot, or a camera. When the ranging apparatus is applied to the UAV, the platform body may be a vehicle body of the UAV. When the ranging apparatus is applied to the car, the platform body may be a body of the car. The car may include an auto-pilot car or a semi-auto-pilot car, which is not limited here. When the ranging apparatus is applied to the remote vehicle, the platform body may be the vehicle body of the remote vehicle. When the ranging apparatus is applied to the robot, the platform body may be the robot. When the ranging apparatus is applied to the camera, the platform body may be a camera body.

Although exemplary embodiments have been described herein with reference to the accompanying drawings, described exemplary embodiments are merely exemplary, and are not intended to limit the scope of the present disclosure. Those of ordinary skill in the art may make various changes and modifications without departing from the scope and spirit of the present disclosure. All these changes and modifications are intended to be included in the scope of the present invention as claimed in the appended claims.

Those of ordinary skill in the art may be aware that the units and algorithm steps of the examples described in embodiments of the present disclosure may be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered as going beyond the scope of the present disclosure.

In some embodiments of the present disclosure, the disclosed device and method may be implemented in another manner. For example, device embodiments described above are only illustrative. For example, the division of the units is only a logical functional division, and another division may exist in actual implementation, for example, a plurality of units or components may be combined or integrated into another device, or some features can be ignored or not implemented.

In the specification provided here, a lot of specific details are described. However, embodiments of the present disclosure may be practiced without these specific details. In some embodiments, well-known methods, structures, and technologies are not shown in detail. Thus, the understanding of this specification may not be obscured.

Similarly, to simplify the present disclosure and help understand one or more of the various aspects of the disclosure, in the description of exemplary embodiments of the present disclosure, the various features of the present disclosure may be sometimes grouped together into a single embodiment, a figure, or its description. However, the method of the present disclosure should not be interpreted as reflecting the intention that the claimed present invention requires more features than those explicitly stated in each claim. More precisely, as reflected in the corresponding claims, the point of the invention is that the corresponding technical problems can be solved with features that are less than all the features of a single disclosed embodiment. Therefore, the claims following specific embodiments are thus explicitly incorporated into the specific embodiments. Each claim itself serves as a separate embodiment of the present invention.

Those skilled in the art can understand that in addition to mutual exclusion between the features, all features disclosed in the specification (including the accompanying claims, abstract, and drawings) and all processes or units of any method or device disclosed in this manner can be combined by any combination. Unless expressly stated otherwise, each feature disclosed in this specification (including the accompanying claims, abstract, and drawings) may be replaced by an alternative feature providing the same, equivalent or similar purpose.

In addition, those skilled in the art may understand that although some embodiments described herein include certain features included in other embodiments but not other features, the combination of features of different embodiments means that they are within the scope of the present disclosure and form different embodiments. For example, in the claims, any one of the claimed embodiments may be used in any combination.

Various component embodiments of the present disclosure may be implemented by hardware, or by a software module that runs on one or more processors, or by a combination of the hardware and the software module. Those skilled in the art should understand that a microprocessor or a digital signal processor (DSP) may be used in practice to implement some or all of the functions of some modules according to embodiments of the present disclosure. The present disclosure may be further implemented as a device program (for example, a computer program and a computer program product) for executing a part or all of the methods described here. Such a program for realizing the present disclosure may be stored on a computer-readable medium or may include the forms of one or more signals. Such a signal may be downloaded from an Internet website, or provided in a carrier signal, or provided in any other forms.

The above-mentioned embodiments are used to describe rather than limit the present disclosure. Those skilled in the art can design alternative embodiments without departing from the scope of the appended claims. In the claims, any reference signs located between parentheses should not be constructed as a limitation to the claims. The present disclosure may be implemented with the support of hardware including several different elements and a suitably programmed computer. In the unit claims listing several devices, several of these devices may be embodied in the same hardware item. The use of the words first, second, and third, etc. does not indicate any order. These words can be interpreted as names.

What is claimed is:

1. A ranging apparatus comprising:
an emitter configured to emit a light pulse sequence;
a scanner configured to change a transmission direction of the light pulse sequence to transmit in different directions in sequence to form a scan field, the scan field including a first region and a second region, and a scan density of the first region being greater than a scan density of the second region;
a detector configured to receive a reflected light pulse sequence formed by an object reflecting the light pulse sequence and determine at least one of a distance or an orientation of the object relative to the ranging apparatus according to the reflected light pulse sequence; and
a controller configured to control the emitter to emit the light pulse sequence at a first emission frequency when scanning the first region and at a second emission frequency higher than the first emission frequency when scanning the second region.

2. The ranging apparatus of claim 1, wherein:
the controller is further configured to control the emission device to emit the light pulse sequence at a fixed emission cycle;
the first region includes at least a non-light-emitting path, a time length needed for the scanner to scan the non-light-emitting path being longer than the emission cycle; and
the controller is further configured to, in response to determining that the non-light-emitting path is scanned, control the emission device not to emit light pulse.

3. The ranging apparatus of claim 1, wherein the controller is further configured to:
limit a light-emitting count of the light pulse sequence emitted by the ranging apparatus to at least the first region within a certain time length to be smaller than or equal to a threshold count.

4. The ranging apparatus of claim 1, wherein:
the scan field includes a light-emitting region and a non-light-emitting region; and
the controller is configured to:
in response to the light-emitting region being scanned, control the emission device to emit light pulses; and
in response to the non-light-emitting region being scanned, control the emission device not to emit light pulses.

5. The ranging apparatus of claim 1, wherein:
the scan field includes a center region, a boundary region, and a middle region located between the center region and the boundary region, scan densities of the center region and the boundary region being greater than a scan density of the middle region.

6. A scan field balance method comprising:
emitting a light pulse sequence;
changing, via a scanner of a ranging apparatus, a transmission direction of the light pulse sequence to transmit in different directions in sequence to form a scan field, the scan field including a first region and a second region, and a scan density of the first region being greater than a scan density of the second region;
receiving a reflected light pulse sequence formed by an object reflecting the light pulse sequence; and
determining at least one of a distance or an orientation of the object relative to the ranging apparatus according to the reflected light pulse sequence;
wherein a first emission frequency of the light pulse sequence for scanning the first region is lower than a second emission frequency of the light pulse sequence for scanning the second region.

7. The balance method of claim 6,
wherein:
emitting the light pulse sequence includes emitting the light pulse sequence at a fixed emission cycle; and
the first region includes a non-light-emitting path, a time length needed for the scanner to scan the non-light-emitting path being longer than the emission cycle;
the balance method further comprising:
in response to determining that the non-light-emitting path is scanned, controlling not to emit light pulse.

8. The balance method of claim 7,
wherein:
the non-light-emitting path is a first non-light-emitting path;
the second region includes a second non-light-emitting path; and
the time length needed for the scanner to scan the first non-light-emitting path is longer than a time length needed for the scanner to scan the second non-light-emitting path;
the balance method further comprising:
in response to determining that the first non-light-emitting path or the second non-light-emitting path is scanned, controlling not to emit light pulse.

9. The balance method of claim 8, wherein:
the first non-light-emitting path is one of one or more first non-light-emitting paths of the first region, and the second non-light-emitting path is one of one or more second non-light-emitting paths of the second region; and
a total time length needed for the scanner to scan the one or more first non-light-emitting paths is longer than a total time length needed for scanning the one or more second non-light-emitting paths.

10. The balance method of claim 8, wherein:
the first non-light-emitting path is one of one or more first non-light-emitting paths of the first region, and the second non-light-emitting path is one of one or more second non-light-emitting paths of the second region; and
a quantity of the one or more first non-light-emitting paths is greater than a quantity of the one or more second non-light-emitting paths.

11. The balance method of claim 6, further comprising:
limiting a light-emitting count of the light pulse sequence emitted by the ranging apparatus to at least the first region within a certain time length to be smaller than or equal to a threshold count.

12. The balance method of claim 11, wherein:
the certain time length is a scan cycle for the scanner to form a complete scan pattern in the scan field; and
the threshold count is smaller than a total emission count of light pulses for the scanner to scan the first region within the scan cycle by emitting the light pulse sequence at the fixed emission cycle.

13. The balance method of claim 11,
wherein the threshold count is a first threshold count;
the method further comprising:
limiting a light-emitting count of the light pulse sequence emitted by the ranging apparatus to at least the second region within the certain time length to be smaller than or equal to a second threshold count.

14. The balance method of claim 11, wherein:
a scan cycle for the scanner to form a complete scan pattern in the scan field is divided into a plurality of time sections; and
the certain time length is any of the plurality of time sections, a sum of any several ones of the plurality of time sections, or each of the plurality of time sections.

15. The balance method of claim 11, wherein limiting the light-emitting count of the light pulse sequence emitted by the ranging apparatus to at least the first region to be smaller than or equal to the threshold count includes:
counting the light-emitting count of the first region; and
controlling not to emit the light pulse sequence in response to the light-emitting count reaching the threshold count within the certain time length.

16. The balance method of claim 15, wherein limiting the light-emitting count of the light pulse sequence emitted by the ranging apparatus to at least the first region to be smaller than or equal to the first threshold count further includes:
setting the light-emitting count to zero at an end of the certain time length; and
limiting a light-emitting count of the light pulse sequence emitted by the ranging apparatus to at least the first region within a next certain time length to be smaller than or equal to the threshold count.

17. The balance method of claim 6, wherein:
the scan field includes a light-emitting region and a non-light-emitting region; and
the first emission frequency being lower than the second emission frequency is realized by:
in response to scanning the light-emitting region, emitting light pulses; and
in response to scanning the non-light-emitting region, not emitting light pulses.

18. The balance method of claim 17, wherein the first emission frequency being lower than the second emission frequency is realized by:
determining a next light-emitting region according to a light-emitting region that is currently scanned by the scanner; and
in response to the scanner scanning the next light-emitting region, emitting the light pulse sequence.

19. The balance method of claim 17, wherein emitting light pulses in response to scanning the light-emitting region includes:
emitting a light pulse each time the light-emitting region is scanned; or
emitting a plurality of light pulses continuously at a fixed frequency each time the light-emitting region is scanned.

20. The balance method of claim 6, wherein:
the scan field includes a center region, a boundary region, and a middle region located between the center region and the boundary region, scan densities of the center region and the boundary region being greater than a scan density of the middle region.

21. The balance method of claim 6, wherein:
a scan density of the first region is greater than a scan density of the second region in a scan cycle, the scan cycle being a period of time for the scanner to form a complete scan pattern in the scan field.
